(19) United States
(12) Patent Application Publication
(10) Pub. No.: US 2013/0132172 A1
(43) Pub. Date: May 23, 2013

(54) Method and Apparatus for Context Adjusted Consumer Capture

(71) Applicants: Yimin Liu, Ann Arbor, MI (US); Perry Robinson MacNeille, Lathrup Village, MI (US); Oleg Yurievitch Gusikhin, West Bloomfield, MI (US); Scott Michael Kelly, Harrison Township, MI (US); Mark Schunder, South Lyon, MI (US)

(72) Inventors: Yimin Liu, Ann Arbor, MI (US); Perry Robinson MacNeille, Lathrup Village, MI (US); Oleg Yurievitch Gusikhin, West Bloomfield, MI (US); Scott Michael Kelly, Harrison Township, MI (US); Mark Schunder, South Lyon, MI (US)

(73) Assignee: Ford Global Technologies, LLC, Dearborn, MI (US)

(21) Appl. No.: 13/300,892

(22) Filed: Nov. 21, 2011

(51) Int. Cl. G06Q 30/02

(52) U.S. Cl. 705/14.5; 705/14.62

(57) ABSTRACT

In a first illustrative embodiment, a computer implemented method includes obtaining the identities of one or more vehicle occupants. The method also includes obtaining data relating to a current vehicle environment. The method further includes selecting an advertisement for delivery based at least in part on data retrieved respective to identified occupants and data relating to the vehicle environment. Also, the illustrative method includes evaluating a driver cognitive load. The method additionally includes providing the selected advertisement for delivery based on the driver cognitive load being below a suitable threshold.

### TECHNICAL FIELD

The illustrative embodiments generally relate to a method and apparatus for context adjusted consumer capture.

### BACKGROUND

Advanced vehicle computing systems, including modern infotainment systems, have the capability to deliver “tailored” content to one or more users based on input or observed user preferences. Typically, however, these preferences are somewhat limited in scope, and because there is a disconnect between the content provider and a vehicle, the content provider lacks a significant portion of available information that could be used in the selection of media. For example, a content provider may know that a certain user likes country music. Accordingly, media and advertising relating to country music may be delivered to that user. The delivery decision, however, is often based on a fixed set of preferences, which are, often due to lack of real-time information, or an inability to obtain advanced information, predetermined and incapable of adaptation to dynamic considerations that may affect a desired user output.

Further, advertisements provided through these mediums may often be generalized at a high level, and may not be as targeted as they could be if additional information were available. One example of an attempt to address this situation can be found in U.S. Pat. App. Pub. 2010/0293033, which generally addresses: “Systems and methods are provided for delivering contextual advertising to a vehicle. An example system may include a profiler module executed by an onboard computing device of the vehicle, and configured to aggregate vehicle event data from a plurality of vehicle-based event sources, and to develop user profile data based on the vehicle event data. A communication agent may also be executed by the onboard computing device, and configured to transmit the user profile data to an advertising service executed on an advertising server via a communication network. The communication agent may also be configured to retrieve an advertisement from the advertising service. The advertisement may be selected based on content of the user profile data. The system may also include an interface module executed by the onboard computing device, and configured to present the advertisement via a display, and/or speaker associated with the onboard computing device.”

### SUMMARY

In a first illustrative embodiment, a computer implemented method includes obtaining the identities of one or more vehicle occupants. The method also includes obtaining data relating to a current vehicle environment. The method further includes selecting an advertisement for delivery based at least in part on data retrieved respective to identified occupants and data relating to the vehicle environment.

Also, the illustrative method includes evaluating a driver cognitive load. The method additionally includes providing the selected advertisement for delivery based on the driver cognitive load being below a suitable threshold.

In a second illustrative embodiment, a computer readable storage medium stores instructions that, when executed, cause a processor to execute the method including obtaining the identities of one or more vehicle occupants. The executed method also includes obtaining data relating to a current vehicle environment.

Further, the executed method includes selecting an advertisement for delivery based at least in part on data retrieved respective to identified occupants and data relating to the vehicle environment and evaluating a driver cognitive load. The executed method additionally includes providing the selected advertisement for delivery based on the driver cognitive load being below a suitable threshold.

In a third illustrative embodiment, a system includes one or more first sensors operable to gather information relating to vehicle occupants, the information usable in identifying the vehicle occupants. The system further includes one or more second sensors operable to gather vehicle environmental information. Also, the system includes one or more third sensors operable to gather driver cognitive load information and a processor configured to provide the information from at least the first and second sensors to at least one advertisement selection routine. The processor is further configured to provide the information from at least the third sensors to a cognitive load determination routine. The system additionally includes at least one output medium.

In this embodiment, the processor is further configured to receive at least a selected advertisement from the at least one advertisement selection routine. The processor is also configured to provide the received selected advertisement responsive to a received determination from the cognitive load determination routine indicating that advertisement provision is permissible.

### BRIEF DESCRIPTION OF THE DRAWINGS

FIG. 1 shows an illustrative vehicle computing system;

FIG. 2 shows an illustrative example of a contextual advertisement delivery process;

FIG. 3 shows an illustrative example of a user determination process;

FIG. 4 shows an illustrative example of a cognitive load determination process;

FIG. 5A shows an illustrative example of a coupon provision process;

FIG. 5B shows an illustrative example of a coupon tracking process;

FIG. 6 shows an illustrative example of a shopping list evaluation process; and

FIG. 7 shows an illustrative example of a survey presentation process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

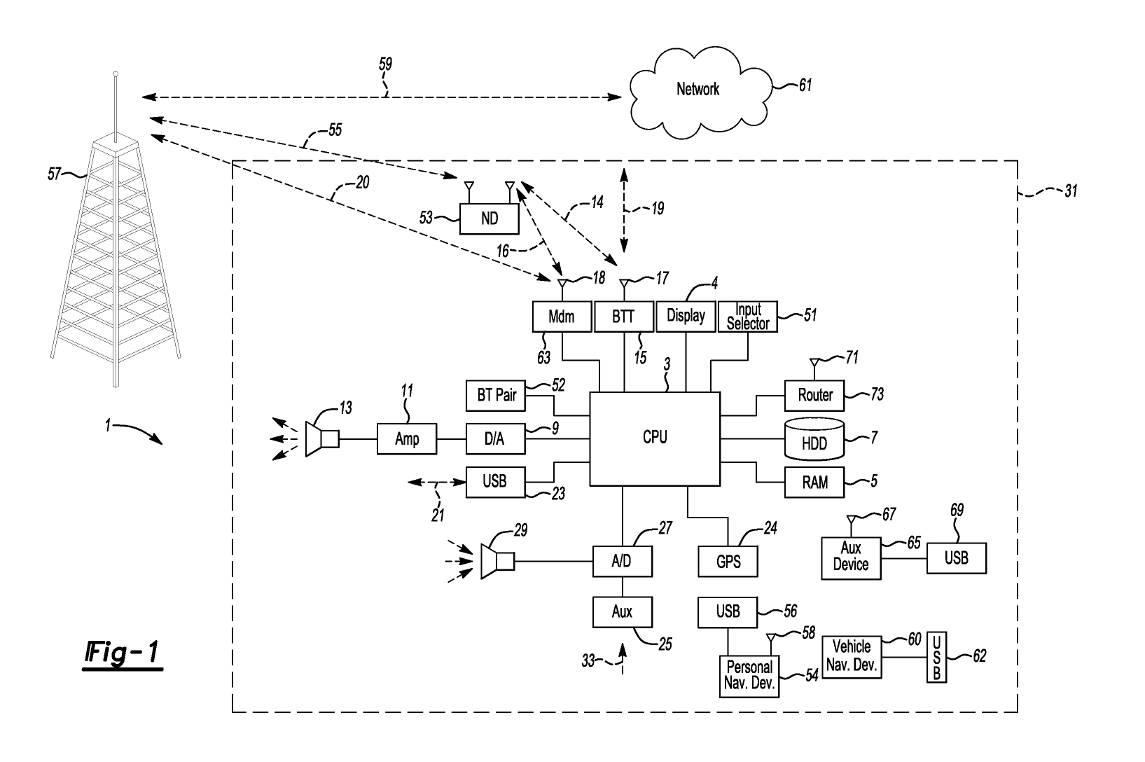

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF signaling associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbps for stationary or walking users and 385 kbps for users in a moving vehicle. 3G standards are now being replaced by IMT-Advanced (4G) which offers 100 mbps for users in a vehicle and 1 gbps for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (Firewire™), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

Vehicle computing systems in conjunction with various sensing capabilities of vehicles are capable of a level of determination of vehicle occupant status previously unseen in modern transportation. Based on detected devices (affiliated with particular users), camera and/or weight sensing devices (which can “recognize” particular users), and a host of other sensors, it is possible to determine, in some instances, precisely which “known” passengers are in a vehicle at a particular time. Even if a given passenger is not known, it may be possible to make some assumptions about the general passenger (such as, for example, the assumption that a 35 lb. passenger is likely a child). In at least one instance, a personalized key present in or used to activate the vehicle can indicate the presence or likely presence of a user associated with the key.

Further, systems can measure the cognitive load and/or stress level of a driver or other vehicle occupant. Based on observed weather and traffic conditions, a driving profile, driver body temperature, heart rate, and other biometric measurements, and/or an additional array of observable conditions and driver/vehicle/environmental states, assumptions can be made by vehicle processes of how much cognitive load a driver or other occupant is currently handling.

For example, without limitation, based on the presence of a particular wireless device in a vehicle, and based on readings taken from interior vehicle cameras and seat sensors, a vehicle computing system may recognize that a driver “Jane” and a passenger “Jim” are both in a vehicle. Further, a clock can indicate that it is currently 3:30 AM (meaning, for example, that it is likely dark outside). Weather sensors, a relay indicating that wipers are engaged, and/or cloud-based computing data can indicate that there is currently a hail storm in the vicinity of the vehicle. Cloud-based traffic data can also indicate that the vehicle is currently in moderate traffic. Based on this information, the system can determine a rough approximation of Jane's cognitive load (which, in this instance, may be “high”), and, if appropriate within a load tolerance, what, if any, media and/or advertisements may be advisable for delivery to Jane and Jim. In this case, it may be that the system foregoes delivery, or, alternatively, provides only “safety” related advertisements, such as local gas and/or hotel options. Other cognitive load determinations could include, but are not limited to, signal light enablement, steering angle reversal quantity measurements, etc.

Usage, selection of, or feedback from provided advertisements can also be used to further tailor future content delivery. In the above example, if the Jane consistently opts to forego the provided advertisements, the system can eventually determine to withhold all advertisements (unless, for example, a low fuel condition is detected).

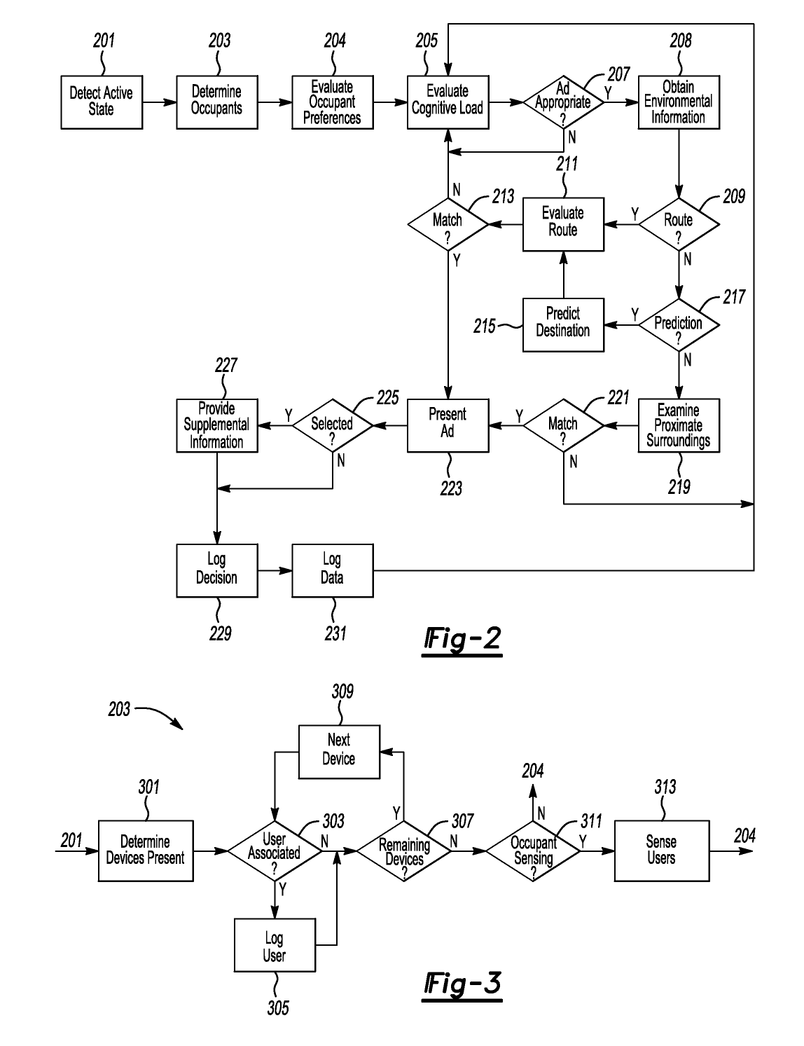

FIG. 2 shows an illustrative example of a contextual advertisement delivery process. In this illustrative example, the process begins by detecting that an advertisement provision state is active 201. If a stereo or other output source is in an “off” position, it may be a clear indication that the driver does not wish to be bothered. Accordingly, at least in this example, the system waits until vehicle outputs are enabled such that advertisement delivery would be appropriate.

Once the ad-state is determined (or in the background, even if an ad-state is disabled), the process, in this example, determines vehicle occupants 203. As previously noted, the system may be capable of using any one of a variety of techniques to determine specifically (or generally) who is in a vehicle. Detection of known passengers through vehicle sensors, or devices known to correspond to specific parties, may aid in the determination of the configuration of vehicle passengers. In the event that specific passengers cannot be identified, weight, height and other general observations made by vehicle sensing systems may be used to make some generalized assumptions about particular passengers.

Once one or more passengers are “known” (or generalized), the process may then evaluate occupant preferences 204. In at least one embodiment, the process doing the actual determining, data retrieval and delivery determinations may be an off-board process, with only data gathering and provision to that process occurring on-board. In another embodiment, aspects of information gathering and evaluation may be split between on-board and off-board processes.

Evaluation of occupant preferences may include retrieval of an occupant profile or, in the case of a generalized observed occupant, retrieval of a generalized profile for the “guessed” demographic. In at least one instance “specifics” about a generalized occupant may even be retrieved. For example, if a particular vehicle demonstrates a preference for McDonald's advertisements every time a child is present in the vehicle, even if the system doesn't know which child is in a vehicle, it could retrieve the specific information that McDonald's advertisements may be preferred if it guesses that any child is in the vehicle (based on, for example, a weight measurement). These “specific generalities” may be linked to, for example, a general vehicle preference file associated with a VIN or other vehicle profile identifier.

In at least one example, occupant data may be aggregated to produce what may be known as vehicle DNA. This can include, but is not limited to, removing conflicting occupant preferences from the data, finding a suitable middle ground for conflicting occupant preferences (e.g., one occupant likes steak, another prefers chicken, so restaurant advertisements may include restaurants that serve both, but that are not exclusive to either, etc.), or taking other action to ensure that commonalities between occupant preferences are given some priority of preference in advertisement/content selection. In one illustrative embodiment, a preference determination algorithm such as Arrow's Exclusion Theorem could be used.

Once relevant occupant information has been retrieved, the process may evaluate a cognitive load of the driver 205. While not necessary, evaluation of a driver's cognitive load may help determine the appropriateness of a particular advertisement, or advertisements in general as discussed previously. If an advertisement provision is acceptable 207, the process may continue, otherwise it may suspend until such time as a cognitive load state dictates that an advertisement can be advisably delivered.

If the advertisement is appropriate, in this example, the process then obtains any relevant environmental contextual information 208. Although not necessary to wait until after the cognitive load step (or even to include the cognitive load step), in this example the process waits until the appropriate time for advertisement delivery to gather environmental information because this information is presumably more subject to change than, for example, occupant information.

Environmental information may include, but is not limited to, time of day, speed of vehicle, weather/traffic conditions, music choices, proximity to destination, current route/destination, etc. Environmental information can even include information about what portable devices are currently present in a vehicle, their capabilities, etc. And it can include information about services currently available to a vehicle (such as, for example, premium OEM provided services).

Next, in this example, the process determines if a current route is input into a vehicle 209. This information can be useful because it allows the process to not only make a determination about available stopping locations in proximity to a present vehicle location, but also available stopping locations that the vehicle may pass by at a later point in time.

If there is no information about a route present in a vehicle, the process may determine if route prediction is available 217 and/or if a predictable destination is determinable. For example, in at least one instance, on-board or off-board software can predict a likely destination of a vehicle given some known factors such as, but not limited to, time of day, driver, current location, etc. In the event that prediction is an available option and/or that a predictable destination can be achieved, the process engages a prediction engine to guess at a likely vehicle destination 215.

If the route is known or predictable, the process then evaluates the route 211 to look for likely matches 213. The match, in this instance, is a correspondence between a particular location at which shopping may be achieved and is also desirable, based on known contextual information. Distinction may also be made between necessary purchases (gas, food, etc.) and discretionary purchases (clothes, general goods, gifts, etc.).

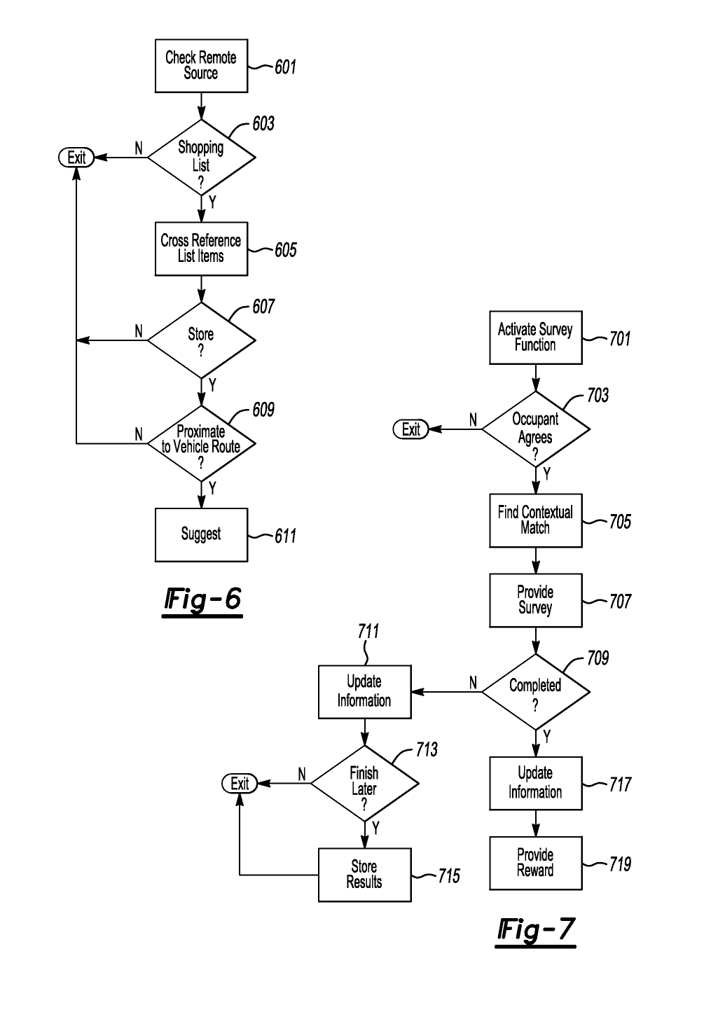

For example, without limitation, if a time of day is relatively proximate to a known or standard lunch time (e.g., drip marketing), and a driver or other vehicle occupant has a history of stopping at or otherwise known preference for fast food at lunch time (e.g., personalized marketing), the system may look for any fast food locations in proximity to some or all of a remaining portion of a route. In another instance, discussed in greater detail with respect to FIG. 6, a driver/occupant has previously indicated one or more shopping items that the party would like to purchase, and the system can determine a congruence between a store selling one of those items and the current route. Other suitable “matches” can also be used to determine the reasonableness of a particular advertisement, such as, but not limited to, a vehicle condition requiring addressing (e.g., low fuel, oil change, maintenance, low tire pressure, etc.) and a proximate location at which the condition can be addressed.

In at least one embodiment, a “match” may also be route independent. For example, certain advertisements may relate to a time of year or other known user preference (sporting goods during a sporting season, lawn care during the spring/summer/fall, etc.). These matches may occur with some reasonable frequency to provide advertisements that a user may wish to take advantage of at some future time. In one instance, they may be given lower priority than advertisements upon which a user may immediately wish to act, although they could also be given an equal distribution chance, higher chance, etc. based on how a system is configured.

If no route or route prediction is available, the process may simply evaluate an area proximate to a user's current known location 219. This could be available, for example, based on a GPS location or other location-determination system. Since the system is continually available, presumably, to track a location and environmental data, relevant advertisements can still be delivered even in the absence of a known route.

Again, a matching process is performed 221, in this case attempting to match suitable advertisements to user preferences that correspond to suppliers available in relative proximity to a user. In at least one example, a user may indicate how far they are willing to travel for a particular item. For example, the user may be willing to drive no more than 10-minutes off-route or away from a current destination in order to obtain food, but may be willing to travel up to 15 minutes off-route to obtain an item on a previously entered shopping list.

Also, again in this case, it may be that one or more advertisements is route/location independent and is selected for delivery based on other factors, such as a congruence with known user preferences.

If a suitable match exists in either of the match determination elements 213, 221, the process presents the selected advertisement to the user 223. This could be a simple advertisement, or it could have an element of interactivity, such as providing a user with a redeemable coupon or an option to receive (now or at later time) additional information relating to the advertisement. Mapping to a related supplier can also be a provided option, as can, for example, menu or pricing information. In at least one embodiment, the customer may be given the option to order on the spot, for example, in a mail order type situation. The corresponding good may then be shipped to the driver. Or, if the driver is interested, but the vehicle is in motion, the driver could indicate interest and be given a later option to order, such as when a vehicle is stopped or at a later time through another mechanism (text or email sent to the driver, for example).

If any selectable information relating to the advertisement is selected 225, the process will provide the additional information 227. Information relating to a user's decision to the respond to the advertisement may also be recorded if appropriate 229. Also, additional information, such as all the current “context” when the advertisement was delivered can be recorded 231 to aid in future determinations of content delivery.

FIG. 3 shows an illustrative example of a user determination process. What is shown with respect to this process are exemplary methods of determining identities of specific vehicle occupants, but these examples are not intended to be exhaustive. In this illustrative example, the process first discover which, if any wireless devices are present in a vehicle 301. If a wireless device is equipped with some form of local, wireless communication, the vehicle computing system may be able to determine the presence of the device based on the detection of a broadcast signal, for example. Further, if the device has previously been introduced to the system, the device may be “known” and may also be affiliated with a particular user. Devices may be identified, for example, through the use of MAC addresses.

Once all devices have been discovered, the process checks to see if a known user is associated with a particular detected device 303. If there is a known user, the process assumes that that user is present, and notes that the user is in the vehicle 305. If any devices remain 307, the process repeats for the remaining devices until all devices are accounted for. Additionally or alternatively, if, for example, another vehicle system indicates that only one person is present, as soon as one identity is determined this process may complete. An enhanced form of Link Layer Discovery Protocol may be employed, in one embodiment, known as Media Endpoint Discovery. Using LLDP-MED numerous devices can be discovered.

Also, this process determines if additional occupant sensing capability is present 311. This can include, but is not limited to, weight sensors, camera sensors, etc. If there is additional capability to sense users (and/or if a currently known number of users have not all been accounted for) the process proceeds to use available measures to determine the identity of or general characteristics of the remaining users 313.

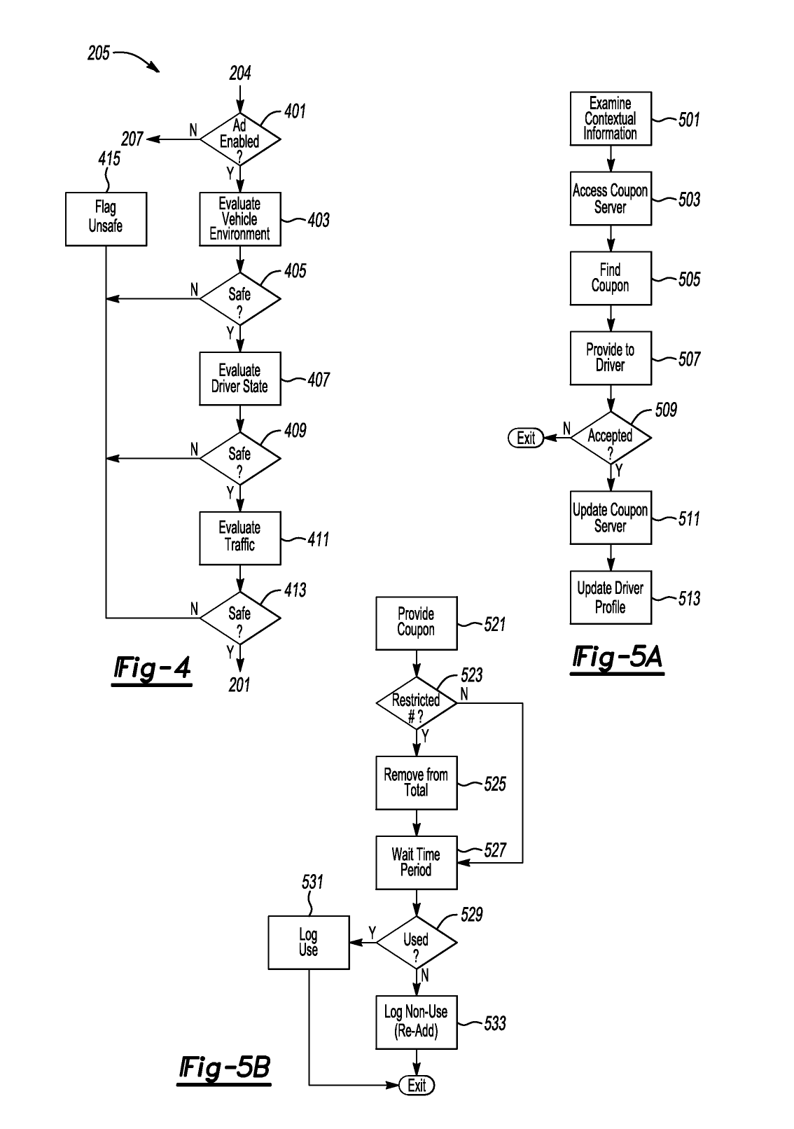

FIG. 4 shows an illustrative example of a cognitive load determination process. The examples shown with respect to this process are meant for illustrative purposes only, and are not intended to be the sole or even necessary means for determining a cognitive load of a driver. In this example, the process determines if an advertisement provision state is enabled (e.g., without limitation, if a display or other output is turned on) 401.

If the state is enabled the process evaluates the vehicle environment 403. This evaluation can include, but is not limited to, weather sensing or information retrieval, engagement of four wheel drive or traction control, engagement of headlights, high beams, fog lights, wipers, defrost settings, application of wiper fluid, time of day, etc. A stop-and-go nature of driving can also be evaluated, for example, to determine high traffic (if, for example, a traffic determination itself is unavailable). Other considerations may include, but are not limited to, a number of occupants, ambient noise level in a vehicle (e.g., without limitation, yelling children), etc.

If the environment is not providing an unsafe load 405, the process continues to evaluating a driver state 407. Driver state determinations can include, but are not limited to, detected biometric changes, erratic driver behavior (as compared, for example, to known baseline behavior), low or muted radio settings, etc. Again, the process then determines if the aggregated load provided by the observed environment plus the observed driver state remains under a “safe” threshold 409.

Also, in this example, the process may evaluate traffic conditions 411. These may be determinable based on observed driver behavior or, for example, through use of alternative traffic data. Vehicle sensors can detect possible traffic conditions, comparisons to current speeds versus known speeds for a given road, or retrieval of real-time traffic conditions can all aid in this particular determination. Once again, the process also determines if the aggregation of all observed possible distractions and situations still provides a “safe” environment for advertisement delivery. Certain information, such as, but not limited to, weather and traffic data, may come from a cloud-based source such as wireless internet or a Radio Data System.

Once all desired variables have been considered, the process will either determine that a current condition is “unsafe” 415 or that proceeding with an advertisement is acceptable and the advertisement provision process may then react accordingly 207.

FIG. 5A shows an illustrative example of a coupon provision process. In this example, some or all of the relevant contextual information is examined by a coupon provision/retrieval process 501. In one example, a server may provide a list of available coupons for particular suppliers 503. In at least one version of the illustrative embodiments, one or more of the coupons is dynamic in nature, such that the server or this illustrative process can “assemble” a coupon based on known user preferences. By providing as context information about other advertisements and coupons the listener has received and information that can be used for market segmentation, the quantity to be purchased, type of vehicle (as a measure of willingness to pay), and the time of purchase the merchant can use price discrimination when issuing coupons or offering reduced prices.

For example, without limitation, if a user is known to positively react to food-based coupons, and is further 50% more likely to react to any deal providing, for example, a buy one get one deal on fast food, the server may allow a custom coupon to be built for that user based on observed behavior. Other suitable coupons may also be assembled or found 505 based on previously observed behavior. In another example, the coupons are static in nature and are either available for retrieval and provision to all or select customers or do not exist.

The retrieved coupon is then provided to a driver 507 and, in this example, may be “accepted” by the driver 509. Driver acceptance of coupons may be relevant for, for example, without limitation, tracking coupons, provision of a related code or delivery of a usable electronic version, or because there are a limited number of the offers available. If the coupon is accepted 509, the process updates a coupon server 511 or other relevant database and provides any additional information to the acceptor as needed. A profile is also updated 513, indicating that the coupon at least resulted in acceptance of the initial offer (follow through will be discussed below).

FIG. 5B shows an illustrative example of a coupon tracking process. In this example, a coupon has either been accepted or is simply provided in usable form 521. In at least one model of coupons, there are a restricted number of available coupons 523 accessible by a coupon server. For example, if a tire store wishes to clear out inventory, it may provide fifty coupons for discounts on new tires. Once those coupons have been used, however, the store may no longer wish to provide discounted tires at that time. In this example, the process addresses this situation by removing the accepted coupon (albeit potentially temporarily) from a total number of available coupons 525.

Whether or not the coupon is from a restricted number of coupons, the process may only wish to keep the coupon valid for a fixed period of time. For example, if the goal was to draw a user to a particular restaurant or in for a particular deal, the process may only wish to have a limited expiration time period (which can be conveyed to a user) on the coupon. In the case of limited deals, unused coupons may be cycled back into the usable supply if unused.

If the time period has expired (in one example, the time period corresponds to a reasonable time period in which a coupon may be used, which may vary based on a particular merchant or offer), the process determines if the coupon has been used 529. This can be tracked based on a redemption code or other suitable means of conveying usage to the coupon or other tracking server.

If the coupon has been used, the process may log the use of the coupon 531. Logging use of the coupon may provide an option to, for example, without limitation, update a user profile, to record usage for an increased fee for advertisement provision, to remove the item from a digital shopping list and to remove the coupon permanently from a limited supply. Similarly, non-use of a selected or provided coupon may be logged for a reduction in advertisement rate, an update of user profile and re-addition of the coupon to the limited supply 533.

FIG. 6 shows an illustrative example of a shopping list evaluation process. In this illustrative example, the process checks a remote (or local) source into which a list of items has been previously input by a vehicle occupant 601. Some of the items may be monthly or weekly purchases, and may be automatically added as certain threshold dates pass. Other items may be specifically input items of need for one time purchases.

If there is a list containing one or more desired items 603, the process cross references the items with a data-source that can provide possible locations for item purchase 605. Data sources can include, but are not limited to, a database, online websites, etc. If at least one merchant is found 607 that provides at least one item, the system may determine if there is a corresponding merchant location proximate to the vehicle or a known route 609. A resulting correspondence may result in suggestion of that particular location and/or a corresponding coupon and add 611. This is yet another example of relevant context that may be considered. If the user uses the coupon and/or stops at the location, the list could be updated by the vehicle computing system as appropriate.

FIG. 7 shows an illustrative example of a survey presentation process. In this illustrative example, instead of providing (or in addition to providing) an advertisement, the content provider will provide a survey relating to, for example, a consumer good or good provider. Other appropriate surveys may also be supplied. In this example, the process may be activated 701 by, for example, an opt-in, a determination that sufficient time remains in a drive to complete a survey, a correspondence between a survey and an add to be provided, etc.

In this process, the occupant is further given the option to agree to a particular survey 703. For example, while the occupant may generally agree to take surveys, in a given instance the occupant may not wish to engage in the survey and may thus decline to participate in a particular survey. Also, in this example, a particular survey is not yet chosen before asking occupant if they wish to participate (although the survey could be chosen in advance). Once the occupant has agreed to participate (possibly in exchange for a promise of a discount or other incentive) the process chooses a contextually appropriate survey 705. In another example, the actual questions in the survey may change based on known context.

The survey is then provided to the occupant for completion 707. If the survey is completed 709, occupant information may be updated, in addition to updating a survey related database 717. Any proffered reward for survey completion may additionally be provided 719.

If the survey is exited before completion (due, for example, to a vehicle shut down, an occupant ending the survey prematurely, etc) information relating to the occupant and/or the survey may also be updated 711. If the occupant has opted to complete the survey later 713, or, for example, if the vehicle power is prematurely terminated and survey completion is saved for later 713, the process may store the current results of the survey 715 for later completion.

Surveys are just another example of contextually based revenue generating material that may be provided to a vehicle occupant based on a vehicle observed/retrieved awareness of contextual occupant and environmental information.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer implemented method comprising:
obtaining the identities of one or more vehicle occupants;
obtaining data relating to a current vehicle environment;
selecting an advertisement for delivery based at least in part on data retrieved respective to identified occupants and data relating to the vehicle environment;
evaluating a driver cognitive load; and
providing the selected advertisement for delivery based on the driver cognitive load being below a suitable threshold.

2. The method of claim 1, wherein the obtaining the identities includes:
communicating with at least one known wireless device in proximity to the vehicle; and
identifying an occupant based on a known correspondence between the occupant and the known wireless device.

3. The method of claim 1, wherein the obtaining the identities includes:
recognizing an occupant through use of vehicle sensors.

4. The method of claim 3, wherein the vehicle sensors include a camera.

5. The method of claim 3, wherein the sensors include a personalized key.

6. The method of claim 3, wherein the vehicle sensors include an occupant weight sensor.

7. The method of claim 1, wherein the data relating to a current vehicle environment includes traffic data.

8. The method of claim 1, wherein the data relating to a current vehicle environment includes weather data.

9. The method of claim 1, wherein the data relating to a current vehicle environment includes vehicle location.

10. The method of claim 1, wherein the data relating to a current vehicle environment includes time of day.

11. The method of claim 1, further comprising:
evaluating a route to be traveled for the presence of one or more merchants corresponding to a selected advertisement, wherein the providing is further based on the presence of the one or more merchants within proximity to the evaluated route.

12. The method of claim 1, further comprising:
evaluating a route to be traveled to determine the presence of one or more merchants;
wherein the selecting further includes selecting an advertisement for delivery based at least on the presence of the one or more merchants.

13. The method of claim 12, further including predicting a driver destination and a corresponding route to be traveled if a route to be traveled is not currently available.

14. The method of claim 1, further comprising aggregating the data retrieved with respect to a plurality of known vehicle occupants into data indicative of all the occupants as a whole, wherein the selecting an advertisement further includes selecting an advertisement likely to appeal to all the occupants as a whole based on the aggregated data.

15. The method of claim 1, further comprising providing at least one coupon in conjunction with the selected advertisement.

16. The method of claim 15, wherein the at least one coupon is customized based at least in part on the data retrieved respective to identified occupants.

17. A computer readable storage medium storing instructions that, when executed, causes a processor to execute the method comprising:
obtaining the identities of one or more vehicle occupants;
obtaining data relating to a current vehicle environment;
selecting an advertisement for delivery based at least in part on data retrieved respective to identified occupants and data relating to the vehicle environment;
evaluating a driver cognitive load; and
providing the selected advertisement for delivery based on the driver cognitive load being below a suitable threshold.

18. The computer readable storage medium of claim 17, wherein the method further includes evaluating a route to be traveled for the presence of one or more merchants corresponding to a selected advertisement, wherein the providing is further based on the presence of the one or more merchants within proximity to the evaluated route.

19. The computer readable storage medium of claim 17, wherein the method further includes evaluating a route to be traveled to determine the presence of one or more merchants; wherein the selecting further includes selecting an advertisement for delivery based at least on the presence of the one or more merchants.

20. A system comprising:
one or more first sensors operable to gather information relating to vehicle occupants, the information usable in identifying the vehicle occupants;
one or more second sensors operable to gather vehicle environmental information;
one or more third sensors operable to gather driver cognitive load information;
a processor configured to provide the information from at least the first and second sensors to at least one advertisement selection routine, the processor further being configured to provide the information from at least the third sensors to a cognitive load determination routine; and
at least one output medium, wherein
the processor is further configured to receive at least a selected advertisement from the at least one advertisement selection routine, wherein
the processor is further configured to provide the received selected advertisement responsive to a received determination from the cognitive load determination routine indicating that advertisement provision is permissible.
